(19) United States
(12) Patent Application Publication
(10) Pub. No.: US 2014/0344251 A1
(43) Pub. Date: Nov. 20, 2014

(54) MAP SEARCHING SYSTEM AND METHOD

(71) Applicant: HON HAI PRECISION INDUSTRY CO., LTD., New Taipei (TW)

(72) Inventors: KUAN-CHIAO PENG, New Taipei (TW); CHUNG-I LEE, New Taipei (TW); YEN-HUNG LIN, New Taipei (TW)

(73) Assignee: HON HAI PRECISION INDUSTRY CO., LTD., New Taipei (TW)

(21) Appl. No.: 14/065,639

(22) Filed: Oct. 29, 2013

(30) Foreign Application Priority Data
May 20, 2013 (CN) 2013101868445

(51) Int. Cl. G06F 17/30

(52) U.S. Cl. CPC G06F 17/30241
USPC 707/722

(57) ABSTRACT

A map searching method using a computing device in communication with a client device is provided. A query area of an electronic map is confirmed according to determining a area selected on an image layer displayed on a display screen of the client device. When a predetermined search command is received, the method parses the query area and a query category to be query information according to a preset format. The method further compares the query information with query data stored in a storage device of the computing device, and obtains query results of the query information. The method outputs the query results in a preset display format to the display screen of the client device.

### BACKGROUND

1. Technical Field

Embodiments of the present disclosure relate to search technology, and particularly to a map searching system and method.

2. Description of Related Art

Map searching services provide a convenient function of querying target content, such as, information of path planning, food information or tour information, for example. Most map searching software generally uses a keyword or a place name to search target information. However, there is often a plurality of information having the same keyword (s), which is inconvenient to search the target information. Furthermore, although a search place corresponding to the place name can be located, the target information in a desired area having no accurate place name cannot be searched conveniently and quickly. Users also cannot search target information of a self-define area.

### BRIEF DESCRIPTION OF THE DRAWINGS

FIG. 1 is a schematic diagram of one embodiment of a map searching system in a server device.

FIG. 2 is a schematic diagram illustrating one embodiment of mesh codes in image layers with different hierarchies.

FIG. 3 is a block diagram of one embodiment of function modules of the map searching system in the server device in FIG. 1.

FIG. 4 is a flowchart illustrating one embodiment of a map search method using the server device in FIG. 1.

FIG. 5 is a schematic diagram illustrating one embodiment of a map search method for confirming selected meshes.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware unit, or to a collection of software instructions, written in a programming language. One or more software instructions in the modules may be embedded in firmware unit, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

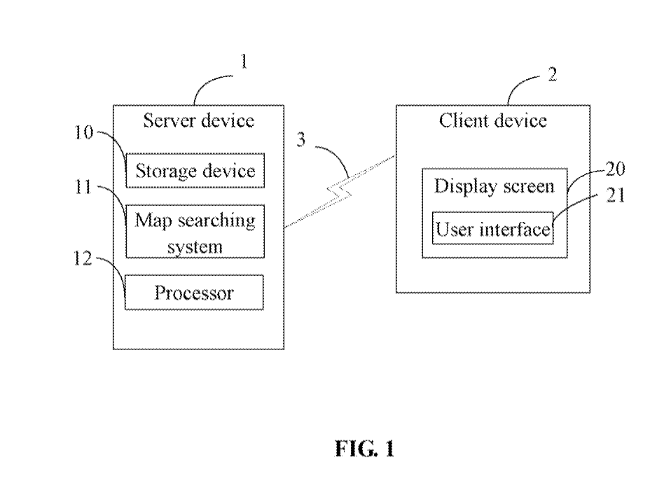

FIG. 1 is a schematic diagram of one embodiment of a map searching system 11 in a server device 1 (e.g., a computing device). The server device 1 communicates with at least one client device 2 through a network 3 (e.g. the Internet or an intranet). The server device 1 further includes a storage device 10 and at least one processor 12. The at least one processor 12 executes one or more computerized codes and other applications of the electronic device 1, to provide functions of the map searching system 11.

The storage device 10 stores preset image layers of an electronic map, the image layers correspond to different hierarchies. In some embodiments, the electronic map may be a navigation map including information (e.g. position names, position information) of a plurality of places, or be a map including information of e-books of an electronic library, or be a map including information of electronic products of an electronic supermarket. The different hierarchies of the image layers represent different scaling (e.g. zoom in/out with different proportions) or different time periods of the image layers of the electronic map.

In one embodiment, each image layer of the electronic map is drawn with a mesh data structure by dividing each image layer into two dimensional (2D) mesh arrays, which include a plurality meshes. Each mesh of one image layer has a same size, and each mesh represents a pixel of the image layer. Each mesh corresponds to a unique code, and each mesh can be divided into smaller sub-meshes.

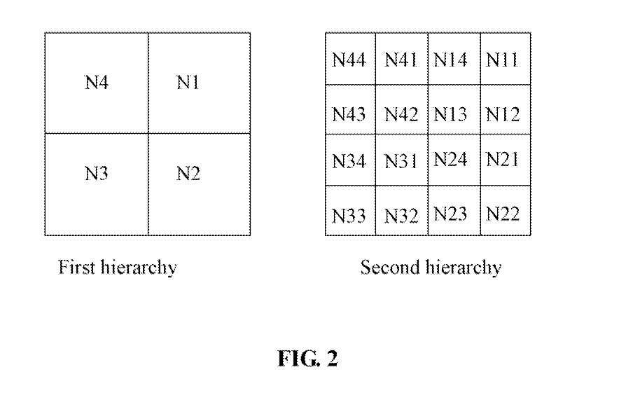

FIG. 2 is a schematic diagram illustrating one embodiment of codes of meshes in image layers of different hierarchies. For example, the code of a mesh can be “HMID=N44”, which represents that the mesh is belonged to be a predefined area N and in the second hierarchy (two numbers representing the second hierarchy). Furthermore, each mesh has a correlation attribute, which represents whether the mesh has been selected. For example, a mesh can be expressed to be {HMID=N44, Selected=true}. The “true” is the attribution of the mesh, which represents that the mesh has been selected. The attribution of each mesh can be set to be “false” initially, which represents that the mesh has not been selected.

The storage device 10 further stores query data corresponding to the code of each mesh in the different hierarchies. The query data represents parameters or information of target objects in the each mesh, such as, position information, a name, an introduction, a category, a miniature of each of the target object, for example. The target object may be a place in the electronic map, an electronic bibliography in an electronic library map, or an electronic entry in an electronic supermarket map.

The client device 2 includes a display screen 20. When the client device 2 requests an image layer to query a target object from the server device 1, the server device 1 provides a user interface 21 to be displayed on the display screen 20. A user can use a mouse, a finger or a stylus to touch or slide an area on the image layer displayed on the display screen 20 to select the area. The selected area is regarded as the query area. The user interface 21 initially displays an image layer of a hierarchy (e.g. the first hierarchy), and provides several functions for users to execute operations on the image layer, such as, functions of zooming in, zooming out, or time period selections, for example.

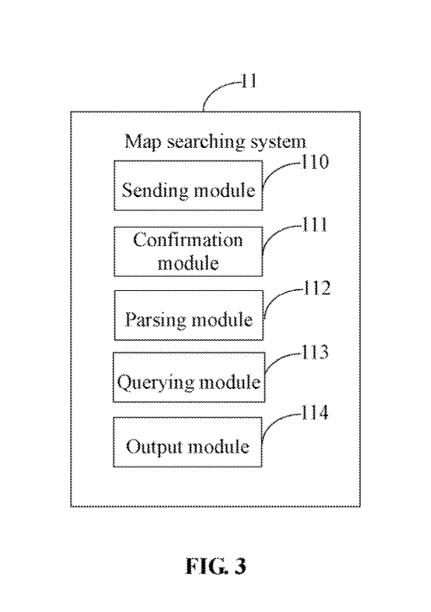

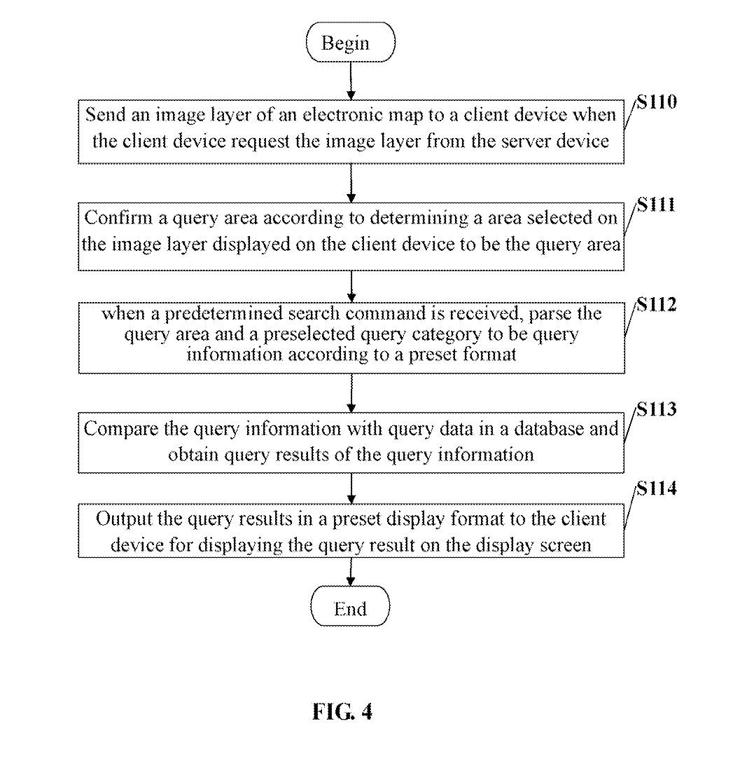

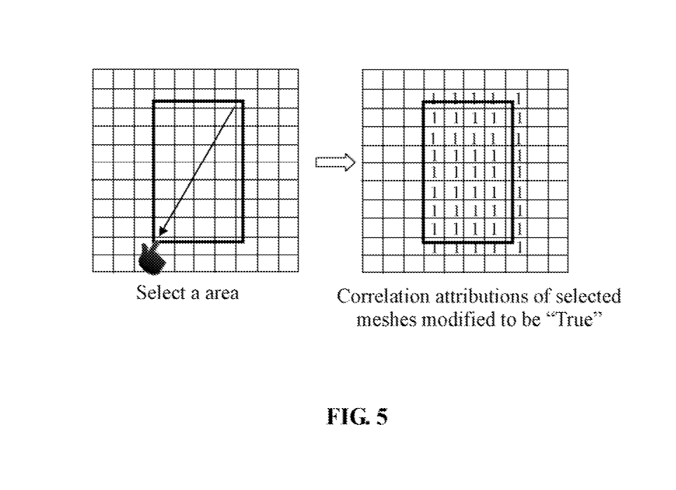

FIG. 3 is a block diagram of one embodiment of function modules of the map searching system 11 in the server device 1 in FIG. 1. In one embodiment, the map searching system 11 includes a sending module 110, a confirmation module 111, a parsing module 112, a querying module 113 and an output module 114. The modules 110-114 comprise computerized codes in the form of one or more programs that are stored in the storage device 10 of the server device 1. The computerized codes include instructions that are executed by the at least one processor 12 to provide functions for the modules. Details of each of the modules will be given in FIG. 4 and FIG. 5.

FIG. 4 is flowchart illustrating one embodiment of a method for managing load of virtual machines. Depending on the embodiment, additional steps may be added, others deleted, and the ordering of the steps may be changed.

In step S110, the sending module 110 sends an image layer of the electronic map to the client device 2, when the client device 2 requests the image layer from the server device 1. Users can use the functions on the user interface 21 to zoom in/out or to select different time periods, and the sending module 110 sends the corresponding hierarchy of image layer to the client device 2. In one embodiment, if one hierarchy of image layer has been sent to the client device to be stored in a storage system in the client device 2 temporarily, the sending module 110 does not send the hierarchy of image layer again. In one embodiment, if the client device 2 does not select hierarchy of image layer by zooming in/out or selecting different time periods, step S111 is implemented directly.

In step S111, the confirmation module 111 confirms a query area by determining an area selected on the image layer displayed on the display screen 20 to be the query area. The confirmation module 111 confirms the query area by recording codes of meshes in the selected area, and modifying correlation attributions of the meshes to be “true”. The users can use a mouse, a finger or a stylus to select an area on the image layer. The query area can be selected using a preset regular shape (e.g. a circle, a rectangle, or a polygon) or an irregular shape randomly operated by the user.

As shown in FIG. 5, if a rectangle is used, after the user slides a beeline on the image layer, the selected area is confirmed by taking the beeline as a diagonal of the rectangle. When the selected area is confirmed, the confirmation module 111 modifies the correlation attributions of the meshes in the selected area to be “true” (denoted as “1” in FIG. 5).

In step S112, when a predetermined search command is received from the client device 2, the parsing module 112 parses the query area and a preselected query category from the user interface 21 to be query information according to a preset format. The preset search command may be triggered by a virtual icon on the display screen 20, or by a button of the client device 2, or triggered after the mouse, the finger or the stylus leaves the display screen 20 and the query area is confirmed. The preset format may be set as “{Hierarchy: 3, query category: fine food, query area: [{HMID:A113}; {HMID:A124}; {HMID:A123}; {HMID:A132}; {HMID:A131}; {HMID:A142}]}. The preset format also can be preset according to actual requirements to make a search be faster and more convenient.

In step S113, the querying module 113 compares the query information with the query data in the storage device 10, and obtains query results of the query information according to the comparison results. In one embodiment, the querying module 113 determines a hierarchy of the image layer according to a hierarchy of the query information, and determines codes of meshes in the query area of the query information. The querying module 113 further confirms one or more target objects which categories match the preselected query category of the query information according to the query data corresponding to the determined codes. The query data of the one or more target objects is determined to be the query results.

In step S114, the output module 114 outputs the query results in a preset display format to the client device 2 for displaying on the display screen 20 of the client device 2. The preset display format may be an anchor point format, or a list entry format. The output module 114 extracts one or more parameters of the one or more target objects according to the preset display format.

For example, if the preset display format is the anchor point format, the output module 114 may extract position information and names of the one or more target objects. The output module 114 outputs the extracted position information and names to the client device 2, and marks the extracted position information with the corresponding names on the image layer to display the query results. If the preset display format is the list entry format, the output module 114 may extract the names of the one or more target objects. The output module 114 outputs the extracted names to the client device 2, and displays a list of the names of the one or more target objects on the display screen 20.

In one embodiment, if one target object is selected by selecting the position information or the name displayed on the display screen 20 is selected, the output module 114 may output all the parameters of the target object to the client device 2 for displaying on the display screen 20 of the client device 2.

All of the processes described above may be embodied in, and be fully automated via, functional code modules executed by one or more general-purpose processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

The described embodiments are merely possible examples of implementations, set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A computer-implemented map search method using a computing device, the computing device in communication with a client device, the method comprising:
confirming a query area of an electronic map by determining a selected area on an image layer of the electronic map displayed on a display screen of the client device;
parsing the query area and a preselected query category to be query information according to a preset format, upon the condition that a predetermined search command is received by the computing device from the client device;
comparing the query information with query data stored in a storage device of the computing device, and obtaining query results of the query information according to the comparing result; and
outputting the query results in a preset display format to the display screen of the client device.

2. The method in claim 1, wherein the image layer is provided by the computing device to the client device when the client device requests the image layer through a network, and the image layer is divided into two dimensional (2D) mesh arrays, which comprises a plurality of meshes having a same size, each of the plurality of meshes representing a pixel of the image layer and corresponding to a unique code.

3. The method in claim 2, wherein the query area is confirmed by recording codes of meshes in the selected area, and modifying attributions of the meshes to be “true” to represent that the meshes have been selected.

4. The method in claim 2, wherein the storage device stores preset image layers corresponding to different hierarchies, the different hierarchies of the image layers representing that different scaling or different time periods corresponding to the image layers, and the storage device further stores query data corresponding to the code of each mesh in the different hierarchies, the query data representing position information, a name, an introduction, a category, a miniature of each target object in the each mesh.

5. The method in claim 4, wherein the query results is obtained by:
determining a hierarchy of the image layer according to a hierarchy of the query information;
determining codes of meshes in the query area of the query information;
confirming one or more target objects which categories match the preselected query category of the query information according to the query data corresponding to the determined codes; and
obtaining query data of the one or more target objects to be the query results.

6. The method in claim 4, wherein the preset display format is an anchor point format or a list entry format, and one or more parameters of the one or more target objects are extracted to output to the client device according to the preset display format.

7. A computing device, in communication with a client device, the computing device comprising:
at least one processor; and
a computer-readable storage medium storing one or more programs, which executed by the at least one processor, the one or more programs causes the at least one processor to:
confirm a query area of an electronic map by determining a selected area on an image layer of the electronic map displayed on a display screen of the client device;
parse the query area and a preselected query category to be query information according to a preset format, upon the condition that a predetermined search command is received by the computing device from the client device;
compare the query information with query data stored in a storage device of the computing device, and obtaining query results of the query information according to the compare result; and
output the query results in a preset display format to the display screen of the client device.

8. The computing device in claim 7, wherein the image layer is provided by the computing device to the client device when the client device requests the image layer through a network, and the image layer is divided into two dimensional (2D) mesh arrays, which comprises a plurality of meshes having a same size, each of the plurality of meshes representing a pixel of the image layer and corresponding to a unique code.

9. The computing device in claim 8, wherein the query area is confirmed by recording codes of meshes in the selected area, and modifying attributions of the meshes to be “true” to represent that the mesh has been selected.

10. The computing device in claim 8, wherein the storage device stores preset image layers corresponding to different hierarchies, the different hierarchies of the image layers representing that different scaling or different time periods corresponding to the image layers, and the storage device further stores query data corresponding to the code of each mesh in the different hierarchies, the query data representing position information, a name, an introduction, a category, a miniature of each target object in the each mesh.

11. The computing device in claim 10, wherein the query results is obtained by:
determining a hierarchy of the image layer according to a hierarchy of the query information;
determining codes of meshes in the query area of the query information;
confirming one or more target objects which categories match the preselected query category of the query information according to the query data corresponding to the determined codes; and
obtaining query data of the one or more target objects to be the query results.

12. The electronic device in claim 10, wherein the preset display format is an anchor point format or a list entry format, and one or more parameters of the one or more target objects is extracted to output to the client device according to the preset display format.

13. A non-transitory computer readable storage medium having stored thereon instructions that, when executed by a processor of a computing device, causes the computing device to perform a map search method using the computing device, the computing device in communication with a client device, the method comprising:
confirming a query area of an electronic map by determining a selected area on an image layer of the electronic map displayed on a display screen of the client device;
parsing the query area and a preselected query category to be query information according to a preset format, upon the condition that a predetermined search command is received by the computing device from the client device;
comparing the query information with query data stored in a storage device of the computing device, and obtaining query results of the query information according to the comparing result; and
outputting the query results in a preset display format to the display screen of the client device.

14. The non-transitory computer readable storage medium in claim 13, wherein the image layer is provided by the computing device to the client device when the client device requests the image layer through a network, and the image layer is divided into two dimensional (2D) mesh arrays, which comprises a plurality of meshes having a same size, each of the plurality of meshes representing a pixel of the image layer and corresponding to a unique code.

15. The non-transitory computer readable storage medium in claim 14, wherein the query area is confirmed by recording codes of meshes in the selected area, and modifying attributions of the meshes to be “true” to represent that the mesh has been selected.

16. The non-transitory computer readable storage medium in claim 14, wherein the storage device stores preset image layers corresponding to different hierarchies, the different hierarchies of the image layers representing that different scaling or different time periods corresponding to the image layers, and the storage device further stores query data corresponding to the code of each mesh in the different hierarchies, the query data representing position information, a name, an introduction, a category, a miniature of each target object in the each mesh.

17. The non-transitory computer readable storage medium in claim 16, wherein the query results is obtained by:
determining a hierarchy of the image layer according to a hierarchy of the query information;
determining codes of meshes in the query area of the query information;
confirming one or more target objects which categories match the preselected query category of the query information according to the query data corresponding to the determined codes; and
obtaining query data of the one or more target objects to be the query results.

18. The non-transitory computer readable storage medium in claim 16, wherein the preset display format is an anchor point format or a list entry format, and one or more parameters of the one or more target objects is extracted to output to the client device according to the preset display format.
